(19) United States
(12) Patent Application Publication
(10) Pub. No.: US 2011/0289820 A1
(43) Pub. Date: Dec. 1, 2011

(54) ANIMAL TRAP WITH BIASED KILL BAR

(76) Inventor: Phillip Waddington, Wellington (NZ)

(21) Appl. No.: 13/139,384

(22) PCT Filed: Dec. 7, 2009
(86) PCT No.: PCT/NZ09/00279

§ 371 Date: Aug. 17, 2011

(30) Foreign Application Priority Data
Dec. 12, 2008 (NZ) 573651
Aug. 14, 2009 (NZ) 579094
Aug. 17, 2009 (NZ) 579119

(51) Int. Cl. A01M 23/30

(52) U.S. Cl. 43/81

(57) ABSTRACT

A baitable animal kill trap having a housing with an opening to allow, from below, the self insertion of the head of a (target species) animal, a kill bar disposed to articulate reproducibly between a set condition and kill position(s), the kill bar (preferably a bar or rod) having an extension externally of the housing accessible to allow the setting of the trap, the unsetting of the trap or the (manual or automatic) reset of the trap, at least one biasing member acting directly or indirectly on the kill bar, and a trigger arm able to be dislodged in the pursuit of a bait by a said animal thereby to first move the kill bar from the set condition and then allow the biasing member(s) to move the kill bar to the kill position(s).

The present invention relates to traps.

Many pests are targeted by specific traps.

In New Zealand possums (opossums—an introduced species) and feral cats (cats are also an introduced species) give rise to a need for control. Possums need to be controlled in order to reduce the exposure of stock and others to tuberculosis as well as to protect the environment. Feral cats need to be controlled in order to protect wildlife and other native species.

A humane kill is usually considered a prerequisite for a kill type trap. Kill type traps are preferred over leg entrapment which can lead to prolonged distress. Traps which merely capture an animal can present a difficulty in that some recovery or kill procedure is necessary before the trap can be reset.

The present invention is directed toward a form of trap able to be baited and considered to be species specific to possums and feral cats but which, with different location of its use, some adjustment of some of its features and by different baiting could be used against other species.

Down scaling of design could be used for squirrels and other small tree climbing animals.

Feature of traps of the present invention are varied and each is an aspect of the invention.

The objects of the invention aspects are diverser and are to provide the public with a useful choice.

In one of its aspects the present invention relates to a trap of a kind having an articulating or pivoted kill bar that operates when set, under the action of a bias, when triggered, preferably within some form of enclosure in order to ensure an appropriate presentation of the target species.

In some aspects the present invention relates to a trap with a lever arm (or the alternative) able to allow a drop off of an already killed animal and/or reset and/or a set of the trap (preferably from outside of some form of enclosure).

In other aspects, the present invention is a trap that lends itself to a kill bar or the equivalent (“kill bar”), kill bar biasing means and a baitable trigger arm being dependent from a component (eg, a frame) separate from the enclosure and/or associable with the enclosure.

In another aspect the invention is a trap of a kind with a over balanced spring bias of a kill bar adapted, when set, to have a trigger arm able to unbalance the overbalanced spring bias.

In another aspect the invention is a trap with a trigger arm carrying a pivotable bait support, allowing, in one disposition ease of bait application and able to assume a stable different disposition (eg, under the affect of gravity).

In still a further aspect the present invention consists in a frame member, associable with some housing or enclosure, yet stably carrying operative components (eg, kill bar, biasing means and trigger arm) of a trap.

In another aspect the invention is a trap having a pivoted or articulably mounted trigger arm able to release a kill bar, the trigger arm carrying a bait support.

In another aspect the invention consists in a trap comprising

a housing adapted to be positioned for trapping an animal, said housing having an access opening for an operator or user and an opening, when the housing is appropriately positioned in use, to allow the self insertion of the head of a (target species) animal,

a closure or part closure (“closure”) for the access opening for the operator or user,

a kill bar disposed to pivotally move or otherwise articulate reproducibly between a set condition and kill position(s) with respect to the housing, the kill bar having an extension (directly or indirectly) externally of the housing accessible to allow at least one of the following, the setting of the trap, the unsetting of the trap or the reset of the trap,

at least one biasing member acting directly or indirectly on the kill bar, and

a trigger arm able to be dislodged in the pursuit of a bait by a said animal thereby to first move the kill bar from the set condition and then allow the biasing member(s) to move the kill bar to the kill position(s).

Preferably said extension is an extension of the rod or bar from which the kill bar is made.

Whilst it is envisaged that, in the manner of a crank, the kill bar can be manually reset (eg, by an integral handle accessible externally of the housing) in some embodiments a reset mechanism is envisaged. This can be a battery, compressed gas, or other powered device able (preferably after a delay after the trap is sprung to ensure a kill) to automatically reset the trap.

In another aspect the invention consists in, in a trap assembly, a frame having

(i) pivot mounts or articulation mounts for a kill bar,

(ii) one or more mounts for a trigger bar, and

(iii) one or more mounts for a bias functionality to act on the kill bar.

In another aspect the invention consists in, a trap assembly, having
(A) a frame with
(i) pivot mounts or articulation mounts for a kill bar,
(ii) one or more mounts for a trigger bar, and
(iii) one or more mounts for a bias functionality to act on the kill bar,
(B) a kill bar rotatable about said mounts from the frame between a set position and kill positions,
(C) a trigger arm mounted from said mount(s) for a trigger bar to be baited or to carry a bait support to be baited, and
(D) at least one biasing member mounted to both said kill bar and said mount(s) for said at least one biasing member,

the arrangement being such that in a set condition the biasing member(s) cannot act to move the kill bar from the set condition to the kill positions until such time as the trigger bar acting on the kill bar moves the kill bar to a condition where the biasing member(s) can so act.

Preferably said trap assembly includes a housing.

Preferably said frame seats in said housing.

Preferably said housing includes one or more opening.

Preferably said frame is formed independently of said housing. In other forms it can be part of said housing.

Preferably said frame is formed from a metal (eg, steel, aluminium or the like) although in other forms it can be fabricated or moulded (eg, in a plastics or other material).

Preferably said pivot mounts or articulation mounts are openings through which the kill bar passes.

Preferably said mount(s) for a trigger bar are openings allowing articulation if not rotation of part of the trigger bar.

Preferably said trigger bar is bifurcated but leads to an unbifurcated region to be baited or carrying the baitable or bait support.

Preferably said bait support is pivotable about an axis longitudinally of part of the trigger bar from which it is mounted.

Preferably said mount(s) for the biasing member is at least one opening.

Preferably said kill bar is in the form of a crank like member having a handle able to be operated to move the kill region of the bar between the conditions mentioned, ie, against the bias in order to achieve set or reset.

In other embodiments as either an optional add-on or as an optional integrated feature there can be an automatic reset mechanism that achieves (preferably after a delay) the equivalent rotation to such a hand crank.

In a further aspect the invention consists in the use of a crank-like bar as a, kill bar of a trap with the crank being rotatable between a set and kill position(s) relative to a frame and/or housing.

In another aspect the invention consists in a trap with any one or more of the features hereinafter described with reference to any one or more of the accompanying drawings.

In yet a further aspect the invention consists in a method of trapping an animal (preferably a possum or feral cat) which involves the operative use of apparatus substantially as herein described With reference to any one or more of the accompanying drawings. Whilst primarily designed for possums and feral cats when to be used in New Zealand, down scaling of design could be used for squirrels and other small tree climbing animals.

In a further aspect the present invention consists in components of a trap or assembly substantially as herein described with or without reference to any one or more of the accompanying drawings.

As used herein the term “and/or” means “and” or “or”, or both.

As used herein the term “(s)” following a noun includes, as might be appropriate, the singular or plural forms of that noun.

As used herein the term “bar” in the case of a kill bar refers to any elongate member (bar, rod, tube, etc) configured or fabricated to have a zone able to act as a kill zone for an animal relative to some surround or other datum or in isolation, eg, purely as a kinetic kill feature.

As used herein the term “housing” includes a single member or an assembly. It may or may not provide a full enclosure whether with a lid or not.

Preferred forms of the present invention will now be described with reference to the accompany drawings in which

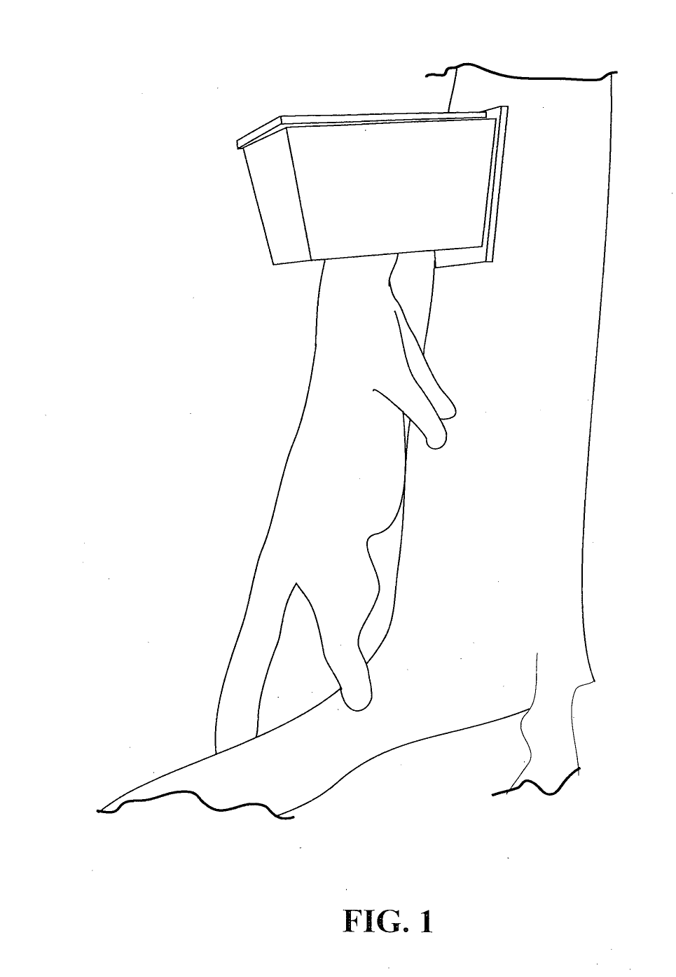

FIG. 1 shows a trap in accordance with the present invention mounted to a tree and having a killed possum hanging therefrom, held in the constricted opening by the kill bar, having been killed under the action of the kill bar on its neck region,

FIG. 2 shows a first embodiment showing (in a set condition of the kill trap with a plastic housing and lid) a metal assembly of a peripheral frame carrying (i) a pivot mounted crank-like shaped bar defining a kill bar with external lever, (ii) a trigger arm (carrying a plastic or other baiting support that pivots relative thereto), and (iii) having two springs as the biasing means acting between the frame and the kill bar,

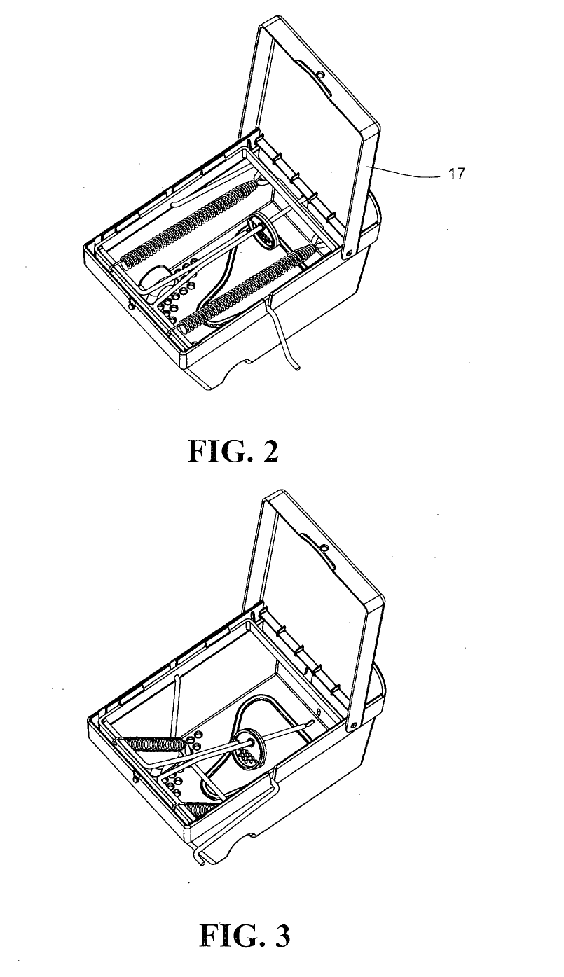

FIG. 3 shows (in a kill condition or unset position) the trap of FIG. 2 with the killing region of the kill bar having been biased almost completely across the constricting lower opening of the housing, the closure being uplifted to allow viewing through the access opening,

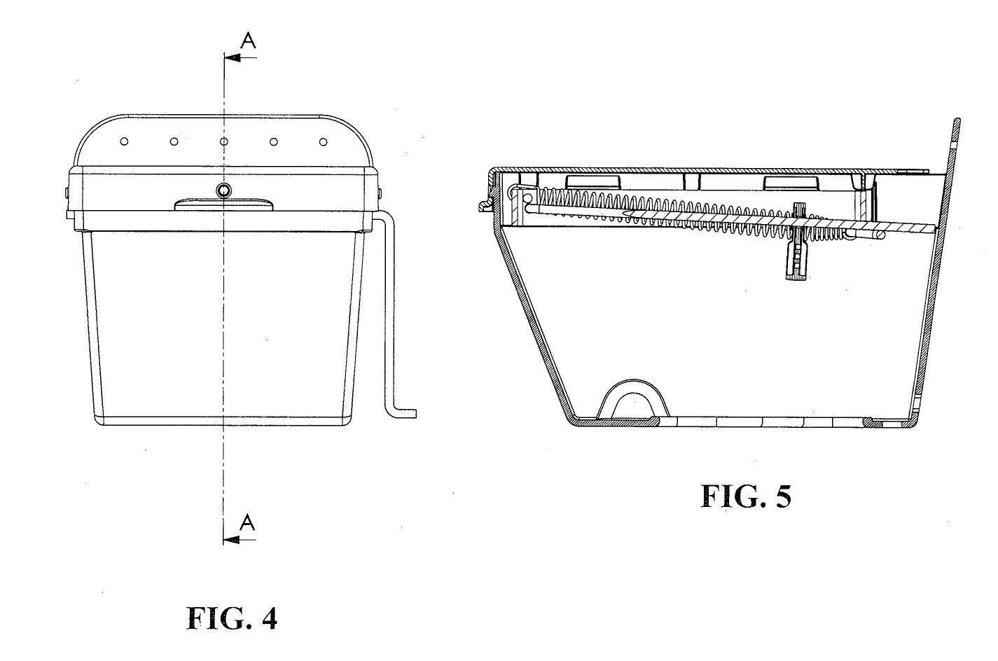

FIG. 4 shows an end view or front view of the trap as in the condition in FIG. 2,

FIG. 5 is the section AA of FIG. 4,

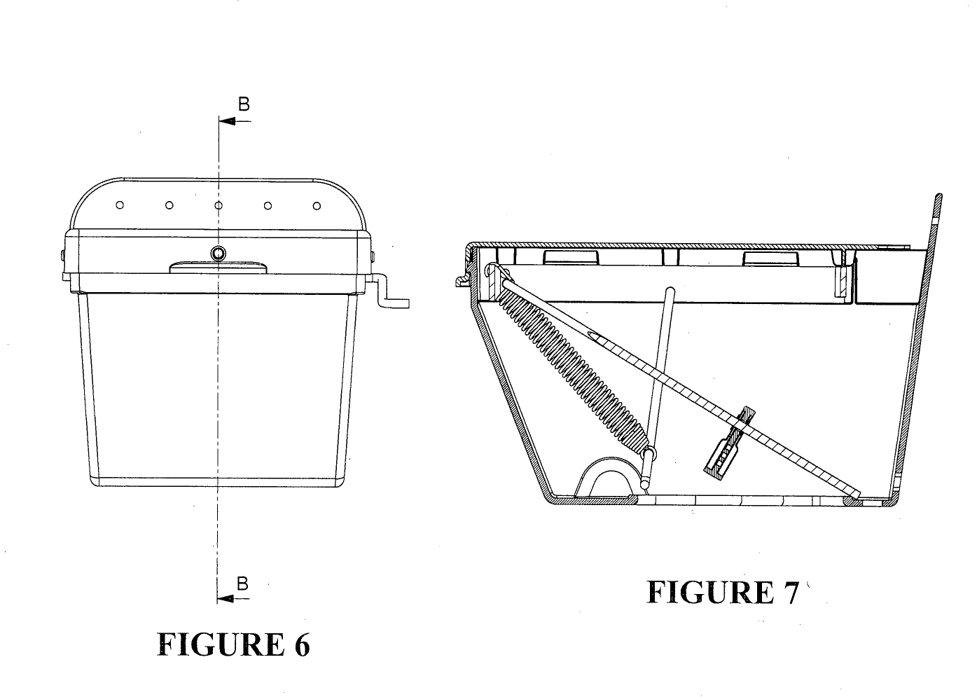

FIG. 6 is a similar front view to that of FIG. 4 but when the trap is in the condition as in FIG. 3,

FIG. 7 is a cross-section BB with respect to the trap of FIG. 6,

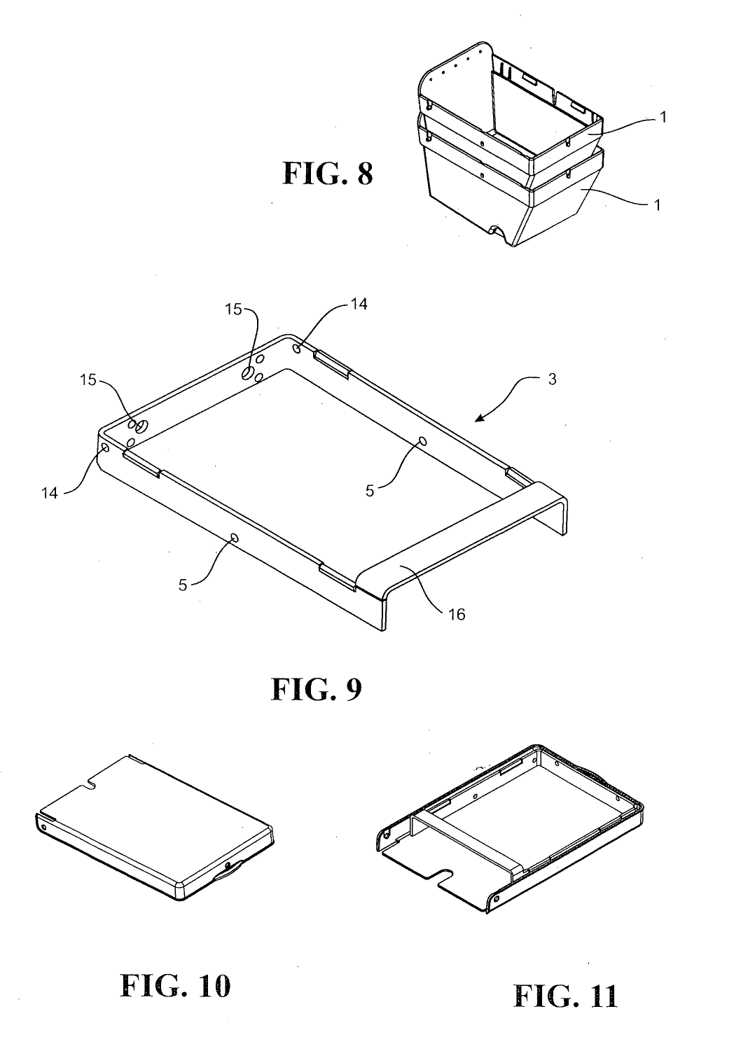

FIG. 8 shows the nesting of moulded plastics housings of a second embodiment of the present invention, such nesting being desirable for ease of storage at site of manufacture, supply, etc, ease of carriage into remote sites whereupon an easy assembly process can then be adopted when the housing is first mounted, (eg, by nailing, screwing or the like to a tree or post) prior to the other components being associated therewith,

FIG. 9 shows a preferred metal, rigid plastics or other material(s) frame, the frame being primarily bar-like save for a change of plane for that part which is to allow butting more upwardly thereagainst of the distal region of the trigger arm in the set condition,

FIG. 10 shows an isometric view of a plastics lid to associate with the housing such as a housing of nested stack of housing shown in FIG. 8.

FIG. 11 shows the member of FIG. 9 nesting in the lid of FIG. 10 for ease of packing for carriage to a site of use upon assembly,

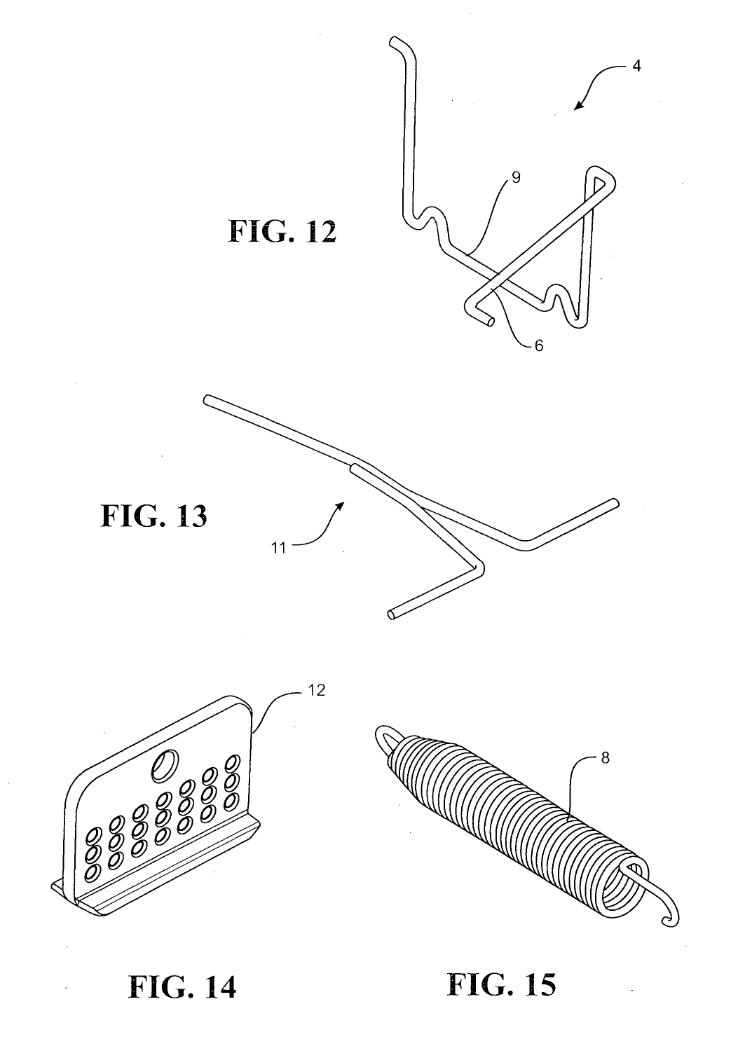

FIG. 12 shows crank-like form as a kill bar with its killing region between regions, each to receive the end of a spring, the kill bar having provision for its pivot mounting in a frame as shown in FIG. 9 by simple thread through, and having the lever externally of the housing,

FIG. 13 shows a preferred bificated trigger arm able to be pivoted by each distal region of its bifurcation from the frame of FIG. 9,

FIG. 14 shows a preferred moulded plastics bait support to which a liquid, paste or solid baiting substance can be applied, or which may be bait impregnated, the larger opening being adapted to allow its pivoting on the single bar region of a trigger arm as shown in FIG. 13,

FIG. 15 is an isometric view of a preferred biasing tensile spring to be used in pairs,

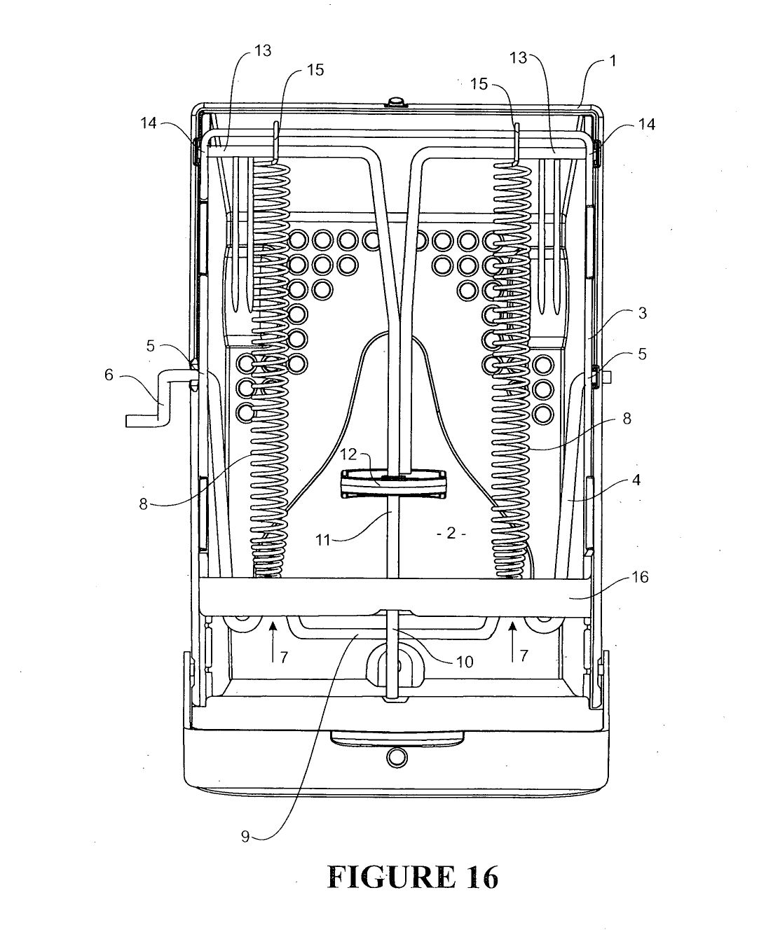

FIG. 16 is a plan view of an assembled trap of components and/or assemblies of FIGS. 8 to 15, when in a set condition (analogously to that described with reference to the embodiment of FIGS. 2 to 7),

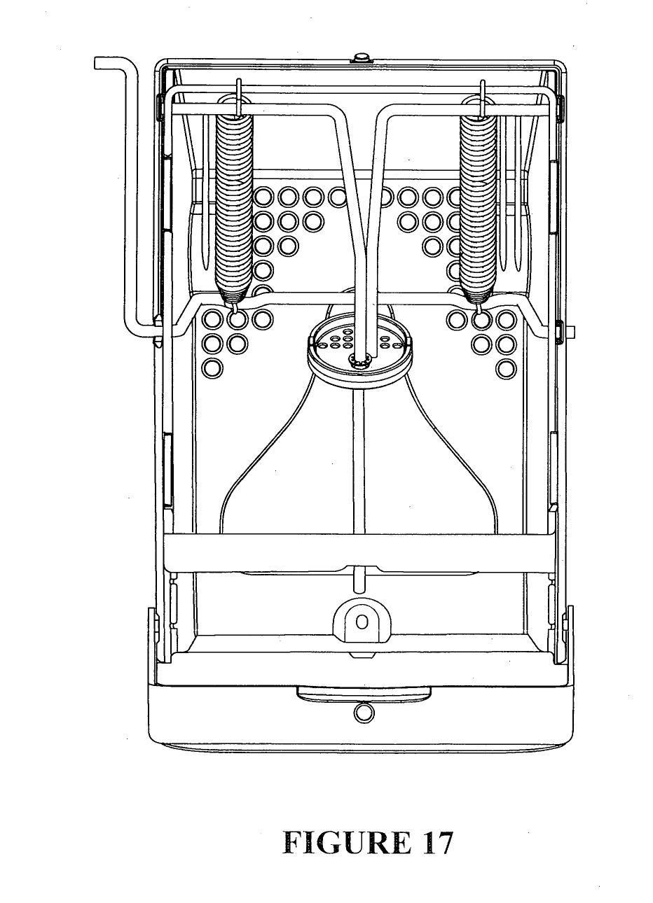

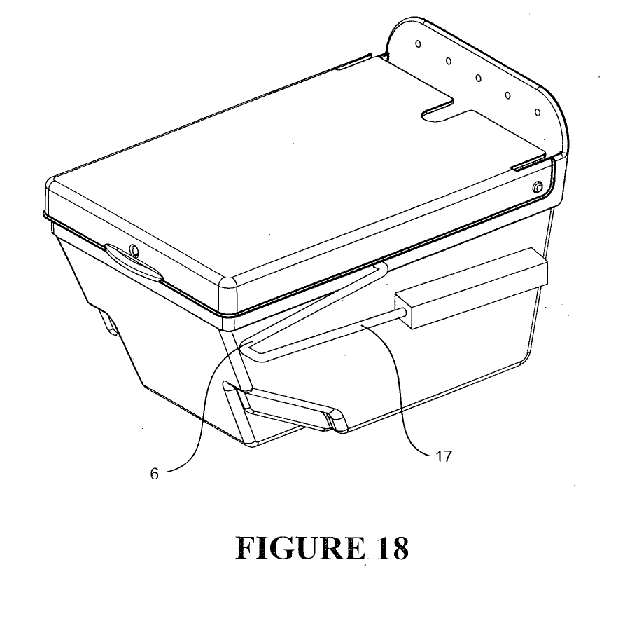

FIG. 17 is a similar view to that of FIG. 16 but showing the trap in a kill condition (or one beyond a kill condition if the neck of a trapped animal (not shown) holds the killing region of the kill bar further back over the constricting lower opening of the housing),

FIG. 18 shows a reciprocating but pivoting assembly capable under battery or compressed fluid power to reset the trap,

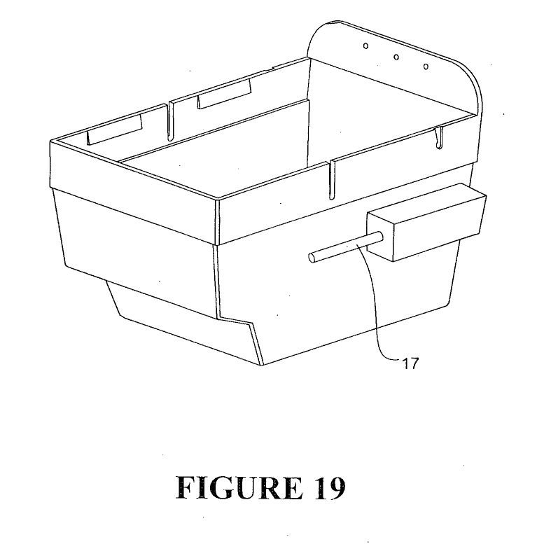

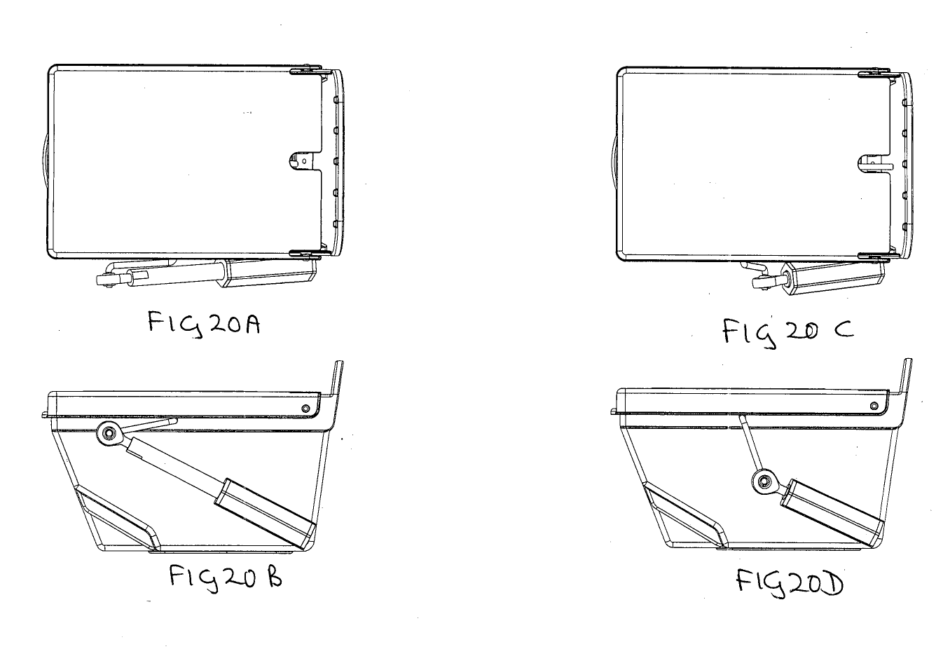

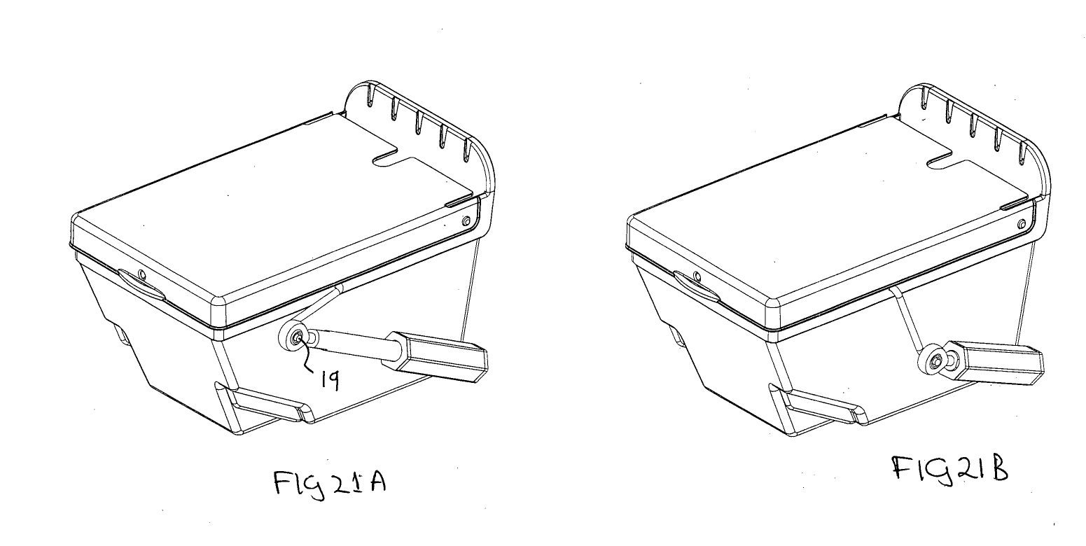

FIG. 19 shows that assembly fitted to a bare trap housing,

FIGS. 20A to 20D show respectively an actuator resettable trap in the plan/unset/actuator extended, in side elevation/unset/actuator extended, in plan/set/actuator compressed and in side elevation/set/actuator compressed,

FIGS. 21A and 21B are isometric views of the trap of FIGS. 20A to 20D respectively unset and set, and

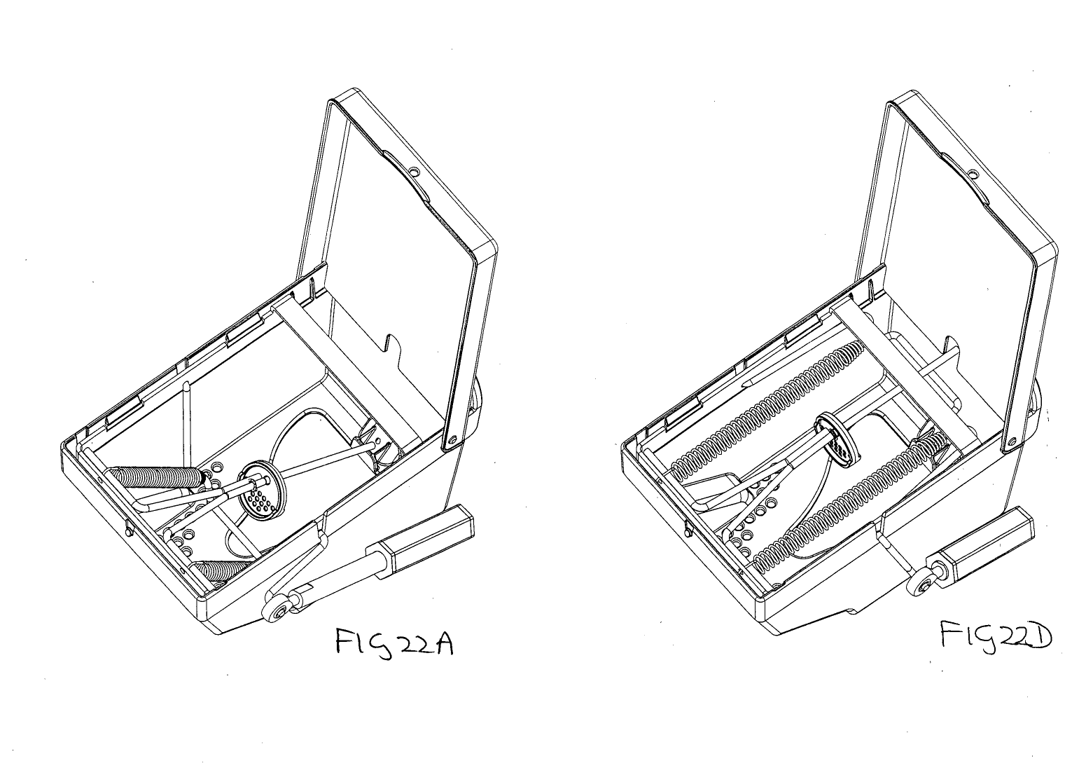

FIGS. 22A and 22B respectively are those of FIGS. 21A and 21B but with lid uplifted.

In respect of the FIGS. 2 to 7, FIG. 2 shows an assembly of a first embodiment of the present invention in the set condition, the trigger bar pivoted from an inner peripheral frame being above the killing region of the kill bar but below the frame, the trap being set with the springs over balanced, (i.e., requiring some movement of the kill bar to an unstable condition prior to the biasing effect taking hold and sweeping the kill bar about its pivot access down to a kill position),

FIG. 8 shows as a stack of housings, housings 1 of an embodiment shown in later drawings, the housing have a constricted opening 2 (see FIG. 16) for an animal.

The frame 3 is located therein and has the kill bar 4 pivot mounted at 5 after its thread through of the frame 3 yet still allowing the nesting of the frame 3 down into the housing 1.

The kill bar 4 includes the external lever of its crank like form. This lever 6 allows the setting or resetting of the trap after release of a captured animal from the trap.

Whilst it is envisaged that, in the manner of a crank, the kill bar can be manually reset (eg, by an integral handle accessible externally of the housing), in some embodiments a reset mechanism is envisaged. This can be a battery, compressed gas, or other powered device able (preferably after a delay after the trap is sprung to ensure a kill) to automatically reset the trap.

Regions 7 of the kill bar are to locate the biasing springs 8 from either flank of the kill region 9 of the kill bar 4.

To lie above the kill bar region 9 is the distal region 10 of the trigger arm 11 with its rotatable bait or bait support 12. This rotatable moulded member 12 is gravity biased to allow ease of bait application from above via the lidded access opening.

An item such as that of FIG. 14 may be impregnated with a mix of Cinnamon and plastic or other scented spices or chemical odours.

The trigger arm 11 itself is bifurcated with regions 13 each locating into appropriate openings at 14 of the frame 3, the biasing springs 8 themselves attach at 15 to the frame.

As can be seen in FIG. 9 (and as in FIG. 16) the frame 3 is preferably a bar like member but with the region 16 in a different plane and set more upwardly. This allows the over centre placement of the kill bar so that it requires movement downwardly under the action of the trigger arm 11 as a result of pull down on the bait support 12 prior to the biasing springs 8 taking over and moving the kill bar from the condition shown in FIG. 16 to the condition more or less as shown in FIG. 17.

In the arrangement of FIGS. 18 and 19 a solenoid under battery power (or a bleeding pneumatic system) can utilise a ram 17 that reciprocates to rotate the crank-like kill bar region 6.

As an example see FIGS. 20A to 22B. Here is shown an actuator resettable trap.

FIGS. 20A to 20D show respectively an actuator 18 resettable trap in the plan/unset/actuator extended, in side elevation/unset/actuator extended, in plan/set/actuator compressed and in side elevation/set/actuator compressed. FIGS. 21A and 21B are isometric views of the trap of FIGS. 20A to 20D respectively unset and set, and FIGS. 22A and 22B respectively are those of FIGS. 21A and 21B but with lid uplifted.

FIGS. 20, 20B, 21A and 22A show the actuator 18 in an extended condition while FIGS. 20C, 20D, 21B and 22B show the actuator (connected to the crank at 19) in a compressed reset condition.

A delay in acting can be provided by a logic circuit, a pneumatic bleeding system, or the like to ensure a kill time period prior to reset.

Persons skilled in the art will appreciate how the present invention in its different aspects allows assembly to be simple once the compactable individual components have been carried to a kill line in the forest or elsewhere. In use once mounted and assembled, the external lever of the kill bar avoids messiness during the animal release and the rebaiting and resetting procedure.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

1-23. (canceled)

24. An animal trap comprising
a housing adapted to be positioned for trapping an animal, said housing having an access opening for an operator or user and an animal access opening, the animal access opening when the housing is positioned in use for trapping an animal being appropriately positioned to allow the self insertion of the head of a target species animal,
a crank mounted from the housing itself, or from a frame carried by the housing, the crank being mounted to rotate on a rotational axis so as to reproducibly sweep a kill region of the crank, between its mountings and offset from the rotational axis, from a set condition away from the animal access opening to at least one killing condition adjacent to the animal access opening, and the crank further defining an extension externally of the housing accessible to allow at least one of the following: the setting of the trap, the unsetting of the trap or the reset of the trap,
at least one biasing member acting directly or indirectly on the crank, and
a trigger arm able to be dislodged by an animal in pursuit of a bait to move the crank from the set condition sufficiently to allow the biasing member to move the kill region to said kill condition.

25. The animal trap as claimed in claim 24 wherein the spaced mountings of the crank are provided by a frame carried within the housing.

26. The animal trap of claim 25 wherein the frame is set down into the housing about the access opening for an operator or user.

27. The animal trap of claim 26 wherein, when in a state of disassembly, the housing can at least in part nest in a like housing.

28. The animal trap of claim 24 wherein the housing carries a lid for closing the access opening for an operator or user.

29. The animal trap of claim 28 wherein the lid hinges or is pivoted from the housing.

30. The animal trap of claim 24 wherein there is a lid for closing the access opening for an operator or use, and when in a state of disassembly, the lid can have the frame nested at least in part therein.

31. The animal trap of claim 24 wherein the trigger arm carries or can carry a baitable member.

32. The animal trap of claim 24 wherein said at least one biasing member is at least one spring.

33. The animal trap as claimed in claim 24 wherein there are at least two tension springs as said biasing member(s).

34. The animal trap of claim 33 wherein each tension spring acts on a region flanking the kill region of the crank, but still offset from the rotational axis.

35. The animal trap of claim 26 wherein the, or each at least one, biasing member acts from one region of the frame set into the housing to another region of the frame.

36. The animal trap as claimed in claim 24 wherein said crank is a rod or bar configured as the crank and to provide spaced regions mounted to pivot on said rotational axis and an external handle as said extension.

37. The animal trap as claimed in claim 26 wherein the frame provides
(i) spaced pivot mounts for the crank,
(ii) one or more mounts for the trigger arm, and
(iii) a connection for the or each biasing member to act on the crank.

38. The animal trap of claim 24 wherein, when in a set condition, the animal access opening is accessible by a target species animal from below, and the trigger arm and crank are above the animal access opening in an over balanced condition that first requires unbalancing from the overbalanced condition before a biased downward killing sweep of the kill region of the crank occurs.

39. The animal trap of claim 24 wherein a battery, compressed gas, or other powered device, is able to automatically reset the trap by acting on said crank extension.

40. The animal trap of claim 24 wherein said trigger arm carries a pivotable bait support, allowing, in one disposition ease of bait application and able to assume a stable different disposition (e.g., under the affect of gravity).

41. The frame member of or for an animal trap of claim 25.

42. The In combination, for assembly from an at least partially disassembled form,
plural housings of animal traps as claimed in claim 24;
plural lids;
plural frames;
plural biasing members;
plural trigger arms.

43. Use of a crank-like bar as a kill bar of a trap with the crank being rotatable between a set and kill position relative to a frame set into a housing, the crank-like bar providing a handle externally of the housing able to be used to affect the set or unset condition of the trap.
